(19) United States
(12) Patent Application Publication
(10) Pub. No.: US 2015/0228414 A1
(43) Pub. Date: Aug. 13, 2015

(54) DYE-SENSITIVE SOLAR CELL PASTE, POROUS LIGHT-REFLECTIVE INSULATION LAYER, AND DYE-SENSITIVE SOLAR CELL

(71) Applicant: SUMITOMO OSAK CEMENT CO., LTD., Tokyo (JP)

(72) Inventors: Teppei Yakubo, Shisui-machi Inba-gun (JP); Shingo Takano, Ryugasaki-shi (JP)

(21) Appl. No.: 14/422,757

(22) PCT Filed: Aug. 21, 2013
(86) PCT No.: PCT/JP2013/072338

§ 371 Date: Feb. 20, 2015

(30) Foreign Application Priority Data
Aug. 22, 2012 (JP) 2012-183142

(51) Int. Cl. H01G 9/20

(52) U.S. Cl. CPC H01G 9/209

(57) ABSTRACT

Dye-sensitized solar cell paste which has both high light reflectivity and excellent insulation properties and is capable of forming a porous light reflective insulation layer, the porous light reflective insulation layer obtained by firing the same, and a dye-sensitized solar cell are provided. The dye-sensitized solar cell paste includes insulating particles (A) having a refractive index of 1.8 or more and a volume median particle diameter (D50) in a range of 100 nm to 5,000 nm and insulating particles (B) having a volume median particle diameter (D50) in a range of 1 nm to 30 nm.

### TECHNICAL FIELD

The present invention relates to dye-sensitized solar cell paste, a porous light reflective insulation layer obtained by firing the same, and a dye-sensitized solar cell.

### BACKGROUND ART

As a module for dye-sensitized solar cells, there is a module obtained by sequentially laminating a porous light reflective layer, a porous insulation layer, and a conductive layer on a power generation layer (porous semiconductor layer) obtained by sintering fine semiconductor particles such as titanium oxide or zinc oxide thereon (for example, Patent Literature No. 1).

The porous light reflective layer is provided to effectively use light by reflecting incident light that has passed through the power generation layer toward the power generation layer, and for example, porous light reflective layers containing the particles of titanium oxide, which is a high-refractive index material, are known (Patent Literature No. 2). In addition, the porous insulation layer is provided as a spacer to separate the conductive layer and the power generation layer, and porous insulation layers containing the insulating particles of zirconium oxide, silicon oxide, or the like are known (Patent Literature No. 3).

### CITATION LISt

### Patent Literature

[Patent Literature No. 1] Japanese Laid-Open Patent Publication No. 2003-142171

[Patent Literature No. 2] Japanese Laid-Open Patent Publication No. 2008-16351

[Patent Literature No. 3] Japanese Patent No. 4382873

### SUMMARY OF INVENTION

### Technical Problem

In a case in which the porous light reflective layer and the porous insulation layer are provided as described above, the gap between the conductive layer and the power generation layer becomes long, and thus the diffusion resistance of an electrolyte increases and there are cases in which the photoelectric conversion efficiency decreases.

The present invention has been made in consideration of the problems of the related art, and provides dye-sensitized solar cell paste which has both high light reflectivity and excellent insulation properties and is capable of improving the photoelectric conversion efficiency, a porous light reflective insulation layer obtained by firing the same, and a dye-sensitized solar cell.

### Solution to Problem

As a result of carrying out studies regarding a method for forming a layer having both the function of a porous light reflective layer and the function of a porous insulation layer in order to solve the above-described problems, the present inventors found that, in a case in which particles having a large particle diameter are used in order to improve the reflection efficiency of light, while the photoelectric conversion efficiency improves, the sizes of pores formed among the respective particles increase, and thus the conductive layer and the power generation layer are likely to short-circuit, and therefore the overall power generation efficiency decreases.

As a result of carrying out additional studies in order to solve the above-described problem, the present inventors found that, when a combination of insulating particles having a specific reflective index and a specific particle diameter and insulating particles having a smaller particle diameter than the above-described insulating particles is used, it is possible to improve both the light reflectivity and the insulation properties, and furthermore, the gap between the conductive layer and the power generation layer can be shortened, and consequently, the photoelectric conversion efficiency improves, and thus the present inventors completed the present invention.

That is, the present invention has the following key features.

[1] Dye-sensitized solar cell paste including insulating particles (A) having a refractive index of 1.8 or more and a volume median particle diameter (D50) in a range of 100 nm to 5,000 nm and insulating particles (B) having a volume median particle diameter (D50) in a range of 1 nm to 30 nm.

[2] The dye-sensitized solar cell paste according to [1], in which the particles (A) are particles obtained by carrying out an insulation treatment on surfaces of non-insulating particles (a).

[3] The dye-sensitized solar cell paste according to [2], in which the insulation treatment is a treatment for forming a coat containing one or more selected from silicon compounds, magnesium compounds, aluminum compounds, zirconium compounds, and calcium compounds on the surfaces of the non-insulating particles (a).

[4] The dye-sensitized solar cell paste according to [2] or [3], in which the non-insulating particles (a) are one or more selected from titanium oxide, tin oxide, zinc oxide, niobium oxide, indium oxide, tin oxide-doped indium oxide, antimony-doped tin oxide, and aluminum-doped zinc oxide.

[5] The dye-sensitized solar cell paste according to any one of [1] to [4], in which the particles (B) are oxides or composite oxides of one or more selected from silicon, aluminum, zirconium, calcium, and magnesium.

[6] A porous light reflective insulation layer obtained by firing the dye-sensitized solar cell paste according to any one of [1] to [5].

[7] A dye-sensitized solar cell including the porous light reflective insulation layer according to [6] between a porous semiconductor layer and a conductive layer.

### Advantageous Effects of Invention

The present invention is capable of providing dye-sensitized solar cell paste which has both high light reflectivity and excellent insulation properties and is capable of forming a porous light reflective insulation layer, the porous light reflective insulation layer obtained by firing the same, and a dye-sensitized solar cell.

### BRIEF DESCRIPTION OF DRAWING

FIG. 1 is a schematic constitutional view illustrating an example of a dye-sensitized solar cell of the present invention.

### DESCRIPTION OF EMBODIMENTS

[Dye-Sensitized Solar Cell Paste]

Dye-sensitized solar cell paste of the present invention includes insulating particles (A) having a refractive index of 1.8 or more and a volume median particle diameter (D50) in a range of 100 nm to 5,000 nm and insulating particles (B) having a volume median particle diameter (D50) in a range of 1 nm to 30 nm.

In the present specification, “the volume median particle diameter (D50)” refers to a particle diameter at which the cumulative volume frequency computed using the volume fraction reaches 50% from the small particle diameter side. The measurement method is as described below. In addition, in the present specification, “the insulating particles” means that the particles have a volume resistivity of 1×10¹⁰ Ω·cm or more.

When the paste of the present invention is measured using, for example, a laser diffraction-type particle diameter measurement instrument (manufactured by Horiba Ltd., Serial No. “LA-750”), two peaks are measured, that is, a peak in a range of 1 nm to 30 nm in the distribution and a peak in a range of 100 nm to 5,000 nm in the distribution.

<Particles (A)>

The particles (A) are insulating particles having a refractive index of 1.8 or more and a volume median particle diameter (D50) in a range of 100 nm to 5,000 nm.

When the refractive index is less than 1.8, it is not possible to obtain sufficient light reflection performance. From the viewpoint of improving the light reflection performance, the refractive index is preferably 2.0 or more, more preferably 2.2 or more, still more preferably 2.4 or more, and even still more preferably 2.5 or more.

The volume median particle diameter (D50) of the particles (A) is in a range of 100 nm to 5,000 nm. When the volume median particle diameter (D50) is less than 100 nm, the light reflection performance degrades, and when the volume median particle diameter exceeds 5,000 nm, the insulating performance degrades. From the viewpoint of improving both the light reflection performance and the insulating performance, the volume median particle diameter (D50) of the particles (A) is preferably in a range of 200 nm to 4,900 nm, more preferably in a range of 300 nm to 4,800 nm, still more preferably in a range of 400 nm to 4,700 nm, still more preferably in a range of 450 nm to 4,600 nm, and most preferably in a range of 450 nm to 1,100 nm.

The average primary particle diameter of the particles (A) is preferably in a range of 100 nm to 4, 900 nm, and more preferably in a range of 200 nm to 1,000 nm.

The average primary particle diameter can be computed by measuring the long diameters of, for example, 500 or more particles, and at least 100 or more particles using a transmission electron microscope or a scanning electron microscope, and averaging the long diameters.

The particles (A) are not particularly limited as long as the particles satisfy the numerical ranges of the refractive index and the volume medium particle diameter (D50) and have insulating properties. Particles obtained by carrying out an insulation treatment on the surfaces of non-insulating particles (a) may be used, or insulating particles may be used.

In the insulation treatment, it is possible to forma coat containing one or more selected from silicon compounds, magnesium compounds, aluminum compounds, zirconium compounds, and calcium compounds on the surfaces of the non-insulating particles (a).

Among them, in the treatment, it is preferable to form a coat containing a silicon compound on the surfaces of the non-insulating particles (a), and the silicon compound is preferably tetraethoxysilane.

As a treatment method for forming a coat containing a silicon compound on the surfaces of the non-insulating particles (a), it is possible to use a treatment method in which, for example, the non-insulating particles (a), ethanol, and tetraethoxysilane are stirred together, a liquid mixture of water and ammonia water is added to this solution dropwise at a rate in a range of 1 ml/minute to 100 ml/minute, and the mixture is heated at a temperature in a range of 50° C. to 70° C. for 1 hour to 5 hours.

From the viewpoint of ensuring insulating properties, the thickness of the coat is preferably in a range of 3 nm to 25 nm, more preferably in a range of 5 nm to 20 nm, and still more preferably in a range of 8 nm to 15 nm.

In the present invention, a treatment for forming a coat containing silica and alumina is also preferred.

As a treatment method for forming a coat containing silica and alumina on the surfaces of the non-insulating particles (a), it is possible to use a treatment method in which, for example, the non-insulating particles (a), water, a sodium silicate solution, and a sodium aluminate solution are mixed together, then, the mixture is neutralized using sulfuric acid, and is heated at a temperature in a range of 40° C. to 80° C. for 1 hour to 6 hours.

As the non-insulating particles (a), it is possible to use one or more selected from titanium oxide, tin oxide, zinc oxide, niobium oxide, indium oxide, tin oxide-doped indium oxide, antimony-doped tin oxide, and aluminum-doped zinc oxide. Among them, titanium oxide is preferred.

As particles constituting the non-insulating particles (a), it is also possible to use titanium oxide particles which have a plurality of radially extending projection portions, have ridges at substantially the center portions of the projection portions in the longitudinal direction, and have, overall, a star shape. The star-shaped titanium oxide particles have a number of reflective surfaces, and thus have quite excellent light scattering and reflection effects.

<Particles (B)>

The particles (B) are insulating particles having a volume median particle diameter (D50) in a range of 1 nm to 30 nm.

When the volume median particle diameter (D50) of the particles (B) is less than 1 nm, the particles are likely to agglomerate together, and handling properties deteriorate, which is not preferable. When the volume median particle diameter exceeds 30 nm, gaps are likely to be generated among the particles, and it becomes difficult to ensure sufficient insulating properties. From the viewpoint of handling properties and insulating properties, the volume median particle diameter (D50) of the particles (B) is preferably in a range of 5 nm to 28 nm, more preferably in a range of 10 nm to 26 nm, still more preferably in a range of 12.5 nm to 24 nm, and still more preferably in a range of 15 nm to 22 nm.

The particles (B) are not particularly limited as long as particles have insulating properties, and insulating particles may be used as they are, or insulating particles having an insulating coat provided on the surfaces of the non-insulating particles may be used.

The average primary particle diameter of the particles (B) is preferably in a range of 1 nm to 28 nm, more preferably in a range of 5 nm to 26 nm, still more preferably in a range of 10 nm to 24 nm, and even still more preferably in a range of 12 nm to 22 nm.

As the particles (B), it is possible to use particles of one or more oxides or composite oxides selected from silicon, aluminum, zirconium, calcium, and magnesium. Among them, oxides or composite oxides of silicon, aluminum, zirconium, and magnesium are preferred, and silicon oxide (silica) is more preferred.

As the insulating coat, it is possible to use the same coat as the insulating coat of the particles (A), and among them, a coat containing a silicon compound is preferred.

<Method for Producing Dye-Sensitized Solar Cell Paste>

There is no particular limitation regarding the method for producing dye-sensitized solar cell paste, and dye-sensitized solar cell paste can be produced using a production method described below.

That is, when the particles (A), the particles (B), hexylene glycol, a high-boiling point organic solvent such as terpineol, a cellulose-based resin or an acryl-based resin, and the like are mixed together, the intended paste can be obtained.

[Porous Light Reflective Insulation Layer]

A porous light reflective insulation layer of the present invention is a layer obtained by firing the dye-sensitized solar cell paste of the present invention.

There is no particular limitation regarding the method for firing the porous light reflective insulation layer, but it is preferable to apply the dye-sensitized solar cell paste to a substrate using a well-known method and then fire the paste.

Examples of the method for applying the dye-sensitized solar cell paste to a substrate include methods such as a screen printing method and an ink jet method. Among them, from the viewpoint of facilitating thickness reduction and suppressing production costs, the screen printing method is preferred.

The paste is preferably fired in the atmosphere or an inert gas atmosphere at a temperature in a range of 50° C. to 800° C. for 10 seconds to 4 hours. The paste may be fired once at a single temperature, or may be fired two or more times at different temperatures. The dye-sensitized solar cell paste is preferably fired after being applied and dried.

From the viewpoint of the insulation efficiency, the film thickness of the fired porous light reflective insulation layer is preferably in a range of 5 μm to 50 μm, more preferably in a range of 7 μm to 40 μm, and still more preferably in a range of 9 μm to 30 μm.

In addition, from the viewpoint of efficiently reflecting light on the porous semiconductor layer, the reflectivity of light at a wavelength of 550 nm is preferably 60% or more, more preferably 70% or more, and still more preferably 75% or more.

From the viewpoint of using the porous light reflective insulation layer as an insulation layer, the resistance value of the layer is preferably 1 kΩ or more, more preferably 100 kΩ or more, and still more preferably 10 MΩ or more.

The reflectivity and reflection value of light can be measured using methods described in the following examples.

When a cross-section of the porous light reflective insulation layer is observed using a transmission electron microscope or a scanning electron microscope, the cross-section is observed in a state in which the particles (A) and the particles (B) are mixed together. That is, large particles (A) having a primary particle diameter in a range of 100 nm to 5,000 nm and small particles (B) having a primary particle diameter in a range of 1 nm to 30 nm are observed.

### [Dye-Sensitized Solar Cell]

A dye-sensitized solar cell of the present invention includes the porous light reflective insulation layer of the present invention between a porous semiconductor layer and a conductive layer. Since the dye-sensitized solar cell includes the porous light reflective insulation layer having both the function of the porous light reflective layer and the function of the porous insulation layer, it is possible to shorten the gap between the conductive layer and a power generation layer, and the photoelectric conversion efficiency can be improved.

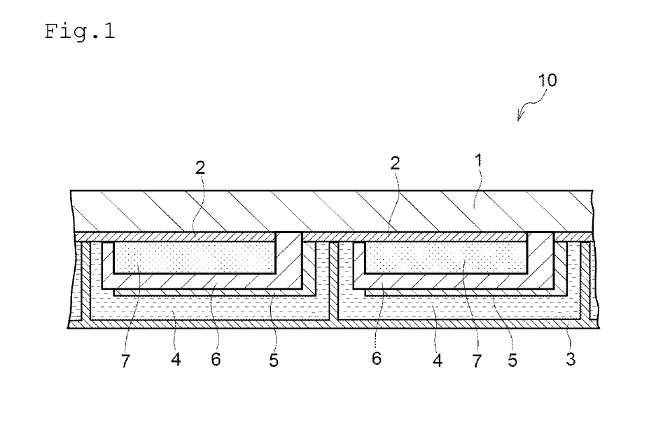

An example of the dye-sensitized solar cell of the present invention is illustrated in FIG. 1. A (serial module-type) dye-sensitized solar cell 10 of the present embodiment includes a transparent substrate 1 including a transparent conductive film 2 and a conductive layer (opposite electrode) 5 provided so as to be opposite to the transparent conductive film 2, and a porous semiconductor layer 7 and a porous light reflective insulation layer 6 are sequentially provided between the transparent conductive film 2 and the conductive layer 5 from the transparent conductive film 2 side. Furthermore, an electrolyte 4 is sealed in a module with a sealing agent 3, and the conductive layer 5 has an end in contact with the transparent conductive film 2.

A catalyst layer (not illustrated) may be provided between the porous light reflective insulation layer 6 and the conductive layer 5.

There is no limitation regarding the porous semiconductor layer 7 and the conductive layer 5 constituting the dye-sensitized solar cell 10; however, specifically, the following constitution can be employed.

<Porous Semiconductor Layer>

The porous semiconductor layer 7 is configured of a semiconductor, and is capable of employing a particulate shape, a film shape, or the like as the shape, but preferably employs a film shape. As a material constituting the porous semiconductor layer 7, it is possible to use one kind of well-known semiconductor particles such as titanium oxide or zinc oxide or a combination of two or more kind thereof. Among them, titanium oxide is preferred in terms of photoelectric conversion efficiency, stability, and safety.

As a method for forming a film-shaped porous semiconductor layer 7 on a substrate, it is possible to employ a well-known method. Specifically, paste containing semiconductor particles is applied to a substrate using a screen printing method, an ink jet method, or the like, and then is fired.

In order to improve the photoelectric conversion efficiency, it is necessary to adsorb a large amount of a dye described below using the porous semiconductor layer 7. Therefore, the film-shaped porous semiconductor layer 7 preferably has a large specific surface area, and more preferably has a specific surface area in a range of 10 m²/g to 200 m²/g. In the present specification, the specific surface area refers to a value measured using a BET adsorption method.

As the semiconductor particles, among commercially available semiconductor particles, particles of a single semiconductor or a compound semiconductor having an appropriate average particle diameter, for example, an average particle diameter in a range of 1 nm to 500 nm can be used.

The porous semiconductor layer 7 is dried and fired under conditions such as temperature, time, and atmosphere which are appropriately adjusted depending on a substrate being used or the kind of the semiconductor particles being contained therein. Regarding the conditions, the porous semiconductor layer is dried and fired, for example, in the atmosphere or an inert gas atmosphere at a temperature in a range of 50° C. to 800° C. for approximately 10 seconds to 4 hours.

(Dye)

As a dye that is adsorbed into the porous semiconductor layer 7 and functions as a photosensitizer, a dye that absorbs light in a variety of visible light ranges and infrared light ranges can be used. In order to strongly adsorb the dye into the porous semiconductor layer 7, the dye preferably has an interlocked group (adsorption functional group) such as a carboxylic group, a carboxylic anhydride group, or a sulfonic acid group among the dye molecules. The interlocked group (adsorption functional group) provides an electrical bond that facilitates the migration of electrons between the dye in an excited state and the conduction band of the porous semiconductor layer.

Examples of dyes containing the interlocked group (adsorption functional group) include ruthenium bipyridine-based dyes, azo-based dyes, quinone-based dyes, quinone imine-based dyes, squarylium-based dyes, cyanine-based dyes, merocyanine-based dyes, polyphyrin-based dyes, phthalocyanine-based dyes, indigo-based dyes, naphthalocyanine-based dyes, and the like.

As a method for adsorbing the dye into the porous semiconductor layer 7, typically, a laminate including the porous semiconductor layer 7 formed on a conductive substrate (transparent conductive film 2) is immersed in a solution produced by dissolving the dye (solution for dye adsorption). Any solvents capable of dissolving the dye can be used as the solvent that dissolves the dye, and specific examples thereof include alcohols called ethanol, ketones called acetone, ethers such as diethyl ether and tetrahydrofuran, nitrogen compounds called acetonitrile, halogenated aliphatic hydrocarbon called chloroform, aliphatic hydrocarbon called hexane, aromatic hydrocarbon called benzene, esters such as ethyl acetate and butyl acetate, water, and the like. It is also possible to use a mixture of two or more solvents.

The concentration of the dye in the solvent can be appropriately adjusted depending on the kind of the dye and the solvent being used. In order to improve the adsorption function, the concentration is preferably as high as possible, and is preferably, for example, 1×10⁻⁵ mol/L or more.

<Conductive Layer>

There is no particular limitation regarding the conductive layer 5 as long as the layer has a capability of reducing an oxidized body of an electrolyte and electric conductivity, and can be preferably formed using a transparent conductive metal oxide such as indium oxide (In₂O₃) into which carbon such as graphite, metal such as platinum, or tin (Sn) is doped, tin oxide (SnO₂) into which fluorine (F) is doped, tin oxide (SnO₂) into which antimony (Sb) is doped, zinc oxide (ZnO) into which aluminum (Al) is doped, zinc oxide (ZnO) into which gallium (Ga) is doped, indium oxide (In₂O₃) into which zinc (Zn) is doped, titanium oxide (TiO₂) into which niobium (Nb) is doped, or titanium oxide (TiO₂) into which tantalum (Ta) is doped. The conductive layer 5 can also be formed using the above-described application method.

<Electrolyte (Electrolytic Solution)>

As the specific examples of the electrolyte 4, a variety of electrolytes such as iodine-based electrolytes, bromine-based electrolytes, selenium-based electrolytes, and sulfur-based electrolytes can be used, and an electrolytic solution obtained by dissolving I₂, Lil, dimethylpropyl imidazolium iodide, or the like as the above-described electrolyte 4 in an organic solvent such as acetonitrile, methoxy acetonitrile, propylene carbonate, or ethylene carbonate is preferably used.

In the dye-sensitized solar cell 10 of the present invention, there is no particular limitation regarding components other than the porous light reflective insulation layer of the present invention, and it is possible to appropriately use components that are ordinarily used in dye-sensitized solar cells.

### EXAMPLES

Hereinafter, the present invention will be described in detail using examples, but the present invention is not limited to the examples by any means.

The volume median particle diameter (D50) of particles is obtained by measuring particles dispersed in distilled water using a laser diffraction-type particle diameter measurement instrument (manufactured by Horiba Ltd., Serial No. “LA-750”) as a measurement instrument.

Regarding the volume resistivity of each particle, a compact was produced using a compact-producing apparatus (manufactured by Mitsubishi Chemical Corporation, Serial No. “PD-51”) so that the thickness fell in a range of 2 mm to 5 mm, and the volume resistivity was measured under a condition of an applied voltage of 100 V using a resistivity measurement instrument (manufactured by Mitsubishi Chemical Corporation, Serial No. “Hiresta-UP”).

### Examples 1 to 3 and Comparative Examples 1 to 3

### Example 1

(Production of Particles (A-1): Production of Titanium Oxide Particles having Surfaces Treated with Silica)

3 g of titanium oxide particles (a-1; manufactured by Sumitomo Osaka Cement Company, Limited, volume resistivity: 1×10⁸ Ω·cm) having a volume median particle diameter (D50) of 500 nm, 150 g of ethanol, and 2 g of tetraethoxysilane were injected into a glass vessel having a capacity of 1 L, were stirred, a liquid mixture of 10 g of water and 3 g of ammonia water (containing an ammonia fraction of 28% by mass) was added dropwise to the solution at a rate of 3 ml/minute, and the mixed solution was heated at 60° C. for 3 hours.

The heated solution was filtered, thereby obtaining particles (A-1) (titanium oxide particles on which a treatment had been carried out using silica). The observation of the particles (A-1) using a transmission electron microscope (TEM: manufactured by Hitachi, Ltd., Serial No. H-800) showed that the surfaces of the particles were coated with silica having a thickness of 10 nm. The volume resistivity of the particles (A-1) was 1×10¹² Ω·cm or more.

(Production of Paste and Porous Light Reflective Insulation Layer)

The particles (A-1), silica particles having a volume median particle diameter (D50) of 20 nm [particles (B-1): manufactured by Nippon Aerosil Co., Ltd., volume resistivity: 1×10¹² Ω·cm or more], ethyl cellulose, and terpineol were mixed together at the ratio described in Table 1, thereby producing paste.

The paste was formed on a transparent conductive substrate (manufactured by Nippon Sheet Glass Company, Ltd.) using a screen printing method so that the fired film thickness reached 10 μm, and was fired at 500° C. for 60 minutes, thereby obtaining a porous light reflective insulation layer-attached substrate.

The light reflectivity of the obtained substrate at a wavelength of 550 nm was measured to be 80%. Regarding the method for measuring the light reflectivity, diffusion reflectivity measurement in which a barium sulfate (manufactured by Kanto Chemical Co . , Inc .) compact was used as a reference was carried out using a Serial No. UV-3150 manufactured by Shimadzu Corporation.

Next, some of the film was evaporated so that the thickness of graphite reached 100 nm, and the electrical resistance between the unprinted portion on the substrate and the graphite film was measured using a tester (manufactured by Custom Corporation, Serial No. CDM-27D). The electrical resistance was 10 MΩ or more .

### Example 2

(Production of Particles (A-2): Production of Titanium Oxide Particles having Surfaces Treated with Silica)

Titanium oxide particles (A-2) on which a treatment had been carried out using silica was obtained in the same manner as in Example 1 except for the fact that titanium oxide particles (a-2; manufactured by Sumitomo Osaka Cement Company, Limited, volume resistivity: 1×10⁸ Ω·cm or more) having a volume median particle diameter (D50) of 1,000 nm were used instead of the titanium oxide particles (a-1) having a volume median particle diameter (D50) of 500 nm.

The observation of the particles (A-2) using a transmission electron microscope (TEM: manufactured by Hitachi, Ltd., Serial No. H-800) showed that the surfaces of the particles were coated with silica having a thickness of 10 nm. The volume resistivity of the particles (A-2) was 1×10¹² Ω·cm or more.

(Production of Paste and Porous Light Reflective Insulation Layer)

Paste and a porous light reflective insulation layer-attached substrate were obtained using the obtained particles (A-2) instead of the particles (A-1) of Example 1.

As a result of the same measurement as in Example 1, the reflectivity of the substrate was 80%.

In addition, the electrical resistance between graphite evaporation formed in the same manner as in Example 1 and the unprinted portion on the substrate was measured using a tester, and the electrical resistance was 10 MΩ or more.

### Example 3

(Production of Particles (A-3): Production of Titanium Oxide Particles having Surfaces Treated with Silica and Alumina)

Titanium oxide particles (a-3; manufactured by Sumitomo Osaka Cement Company, Limited, volume resistivity: 1×10⁸ Ω·cm) having a volume median particle diameter (D50) of 250 nm, water, a sodium silicate solution, and a sodium aluminate solution were mixed together so that the mass ratio between titanium oxide, silica, and alumina reached 90:2:8. Next, the mixture was neutralized using sulfuric acid, and was heated at 60° C. for 3 hours, thereby treating the surfaces of titanium oxide with silica and alumina.

The heated solution was filtered, thereby obtaining particles (A-3) (titanium oxide particles on which a treatment had been carried out using silica and alumina). The observation of the particles (A-3) using a transmission electron microscope (TEM: manufactured by Hitachi, Ltd., Serial No. H-800) showed that the surfaces of the particles were coated with a coat containing silica having a thickness of 10 nm and alumina. The volume resistivity of the particles (A-3) was 1×10¹² Ω·cm or more.

(Production of Paste and Porous Light Reflective Insulation Layer)

Paste and a porous light reflective insulation layer-attached substrate were obtained in the same manner as in Example 1 except for the fact that the particles (A-3) were used instead of the particles (A-1).

As a result of the same measurement as in Example 1, the reflectivity of the substrate was found to be 80%.

In addition, the electrical resistance between graphite evaporation formed in the same manner as in Example 1 and the unprinted portion on the substrate was measured using a tester, and the electrical resistance was 10 MΩ or more.

### Comparative Example 1

A porous light reflective insulation layer-attached substrate was obtained in the same manner as in Example 1 except for the fact that paste was prepared using only the particles (A-1) produced using the above-described method without using particles (B-1). As a result of the same measurement as in Example 1, the reflectivity of the substrate was found to be 80%.

In addition, the electrical resistance between graphite portion formed in the same manner as in Example 1 and the unprinted portion on the substrate was measured using a tester, and the electrical resistance was 50Ω. From this results, it was discovered that graphite passed through the porous light reflective insulation layer and reached even the surface of the substrate.

### Comparative Example 2

A porous light reflective insulation layer-attached substrate was obtained in the same manner as in Example 1 except for the fact that paste was prepared using only the particles (B-1). As a result of the same measurement as in Example 1, the reflectivity of the substrate was found to be 40%.

In addition, the electrical resistance between graphite evaporation formed in the same manner as in Example 1 and the unprinted portion on the substrate was measured using a tester, and the electrical resistance was 10 MΩ or more.

### Comparative Example 3

A porous light reflective insulation layer-attached substrate was obtained in the same manner as in Example 1 except for the fact that the titanium oxide particles used in Example 1 (a-1; manufactured by Sumitomo Osaka Cement Company, Limited) having a volume median particle diameter (D50) of 500 nm were used without carrying out the surface treatment using silica. As a result of the same measurement as in Example 1, the reflectivity of the substrate was found to be 80%.

In addition, the electrical resistance between graphite evaporation formed in the same manner as in Example 1 and the unprinted portion on the substrate was measured using a tester, and the electrical resistance was 3,000Ω.

TABLE 1

| | | Example | | | Comparative Example | | |
|---|---|---|---|---|---|---|---|
| | | 1 | 2 | 3 | 1 | 2 | 3 |
| Blending | Particles | 22 | — | — | 22 | — | — |
| ratios | (A-1) | | | | | | |
| (parts by | (refractive | | | | | | |
| mass) | index = 2.6) | | | | | | |
| | Particles | — | — | — | — | — | 22 |
| | (a-1) | | | | | | |
| | (refractive | | | | | | |
| | index = 2.6) | | | | | | |
| | Particles | 3 | 3 | 3 | — | 18 | 3 |
| | (B-1) | | | | | | |
| | (refractive | | | | | | |
| | index = 2.6) | | | | | | |
| | Particles | — | 22 | — | — | — | — |
| | (A-2) | | | | | | |
| | (refractive | | | | | | |
| | index = 2.6) | | | | | | |
| | Particles | — | — | 22 | — | — | — |
| | (A-3) | | | | | | |
| | (refractive | | | | | | |
| | index = 2.6) | | | | | | |
| | Ethyl | 10 | 10 | 10 | 10 | 8 | 10 |
| | cellulose | | | | | | |
| | Terpineol | 65 | 65 | 65 | 68 | 74 | 65 |
| Assessment | Reflectivity | 80 | 80 | 80 | 80 | 40 | 80 |
| | (%) | | | | | | |
| | Resistance | >1 × 10⁷ | >1 × 10⁷ | >1 × 10⁷ | 50 | >1 × 10⁷ | 3000 |
| | value (Ω) | | | | | | |

### Examples 4 to 6 and Comparative Examples 4 to 6

### Example 4

(Production of Porous Semiconductor Layer)

26 parts by mass of titanium oxide having an average primary particle diameter of 20 nm, 8 parts by mass of ethyl cellulose, and 66 parts by mass of terpineol were mixed together, thereby obtaining paste for forming a porous semiconductor layer.

The obtained paste was screen-printed on a transparent conductive substrate so that the fired film thickness reached 7 μm, and was fired at 500° C.

(Production of Porous Light Reflective Insulation Layer)

Next, the paste obtained in Example 1 was printed on a porous semiconductor layer using screen printing so that the fired film thickness reached 7 μm, and was fired at 500° C.

(Production of Conductive Layer)

A catalyst layer was formed on the obtained porous light reflective insulation layer by evaporating platinum, and then titanium was evaporated, thereby forming a conductive layer. Next, the conductive layer was immersed in a solution of 0.3 mM of a Ru metal dye (black dye, manufactured by Dyesol Ltd.) for 24 hours, thereby obtaining an electrode into which the dye was adsorbed.

(Production of Electrolytic Solution)

As supporting electrolytes, an iodine salt of 1,2-dimethyl-3-propylimidazolium, lithium iodide, iodine, and t-butylpyridine were mixed with acetonitrile so as to reach 0.6 M, 0.1 M, 0.05 M, and 0.5 M respectively, thereby producing an electrolytic solution.

(Production of Dye-Sensitized Solar Cell)

A serial module-type dye-sensitized solar cell illustrated in FIG. 1 was produced using the obtained electrode and the obtained electrolytic solution.

(Assessment of Photoelectric Conversion Efficiency)

The dye-sensitized solar cell of the present example was irradiated with artificial sunlight using a solar simulator (manufactured by Yamashita Denso Corporation), and the I-V characteristics were measured using a current and voltage measurement instrument (manufactured by Yamashita Denso Corporation), thereby obtaining the photoelectric conversion efficiency. As a result, the photoelectric conversion efficiency was found to be 7%.

### Example 5

A dye-sensitized solar cell of Example 5 was produced in the same manner as in Example 4 except for the fact that the paste of Example 2 was used instead of the paste of Example 1.

As a result of measuring the photoelectric conversion efficiency in the same manner as in Example 4, the photoelectric conversion efficiency was found to be 7%.

### Example 6

A dye-sensitized solar cell of Example 6 was produced in the same manner as in Example 4 except for the fact that the paste of Example 3 was used instead of the paste of Example 1.

As a result of measuring the photoelectric conversion efficiency in the same manner as in Example 4, the photoelectric conversion efficiency was found to be 7%.

### Comparative Example 4

A dye-sensitized solar cell of Comparative Example 4 was produced in the same manner as in Example 4 except for the fact that the paste of Comparative Example 1 was used instead of the paste of Example 1.

As a result of measuring the photoelectric conversion efficiency in the same manner as in Example 4, the photoelectric conversion efficiency was found to be 1%.

### Comparative Example 5

A dye-sensitized solar cell of Comparative Example 5 was produced in the same manner as in Example 4 except for the fact that the paste of Comparative Example 2 was used instead of the paste of Example 1.

As a result of measuring the photoelectric conversion efficiency in the same manner as in Example 4, the photoelectric conversion efficiency was found to be 4%.

### Comparative Example 6

A dye-sensitized solar cell of Comparative Example 6 was produced in the same manner as in Example 4 except for the fact that the paste of Comparative Example 3 was used instead of the paste of Example 1.

As a result of measuring the photoelectric conversion efficiency in the same manner as in Example 4, the photoelectric conversion efficiency was found to be 1%.

From the results of the examples and the comparative examples, it is found that the porous light reflective insulation layer formed of the dye-sensitized solar cell paste of the present invention has high reflectivity and is useful as a spacer for separating a conductive layer and a power generation layer.

### REFERENCE SIGNS LISt

1 TRANSPARENT SUBSTRATE

2 TRANSPARENT CONDUCTIVE FILM

3 SEALING AGENT

4 ELECTROLYTE

5 CONDUCTIVE LAYER (OPPOSITE ELECTRODE)

6 POROUS LIGHT REFLECTIVE INSULATION LAYER

7 POROUS SEMICONDUCTOR LAYER

10 DYE-SENSITIZED SOLAR CELL

1. Dye-sensitized solar cell paste comprising:
insulating particles (A) having a refractive index of 1.8 or more and a volume median particle diameter (D50) in a range of 100 nm to 5,000 nm; and
insulating particles (B) having a volume median particle diameter (D50) in a range of 1 nm to 30 nm.

2. The dye-sensitized solar cell paste according to claim 1,
wherein the particles (A) are particles obtained by carrying out an insulation treatment on surfaces of non-insulating particles (a).

3. The dye-sensitized solar cell paste according to claim 2,
wherein the insulation treatment is a treatment for forming a coat containing one or more selected from silicon compounds, magnesium compounds, aluminum compounds, zirconium compounds, and calcium compounds on the surfaces of the non-insulating particles (a).

4. The dye-sensitized solar cell paste according to claim 2,
wherein the non-insulating particles (a) are one or more selected from titanium oxide, tin oxide, zinc oxide, niobium oxide, indium oxide, tin oxide-doped indium oxide, antimony-doped tin oxide, and aluminum-doped zinc oxide.

5. The dye-sensitized solar cell paste according to claim 1,
wherein the particles (B) are oxides or composite oxides of one or more selected from silicon, aluminum, zirconium, calcium, and magnesium.

6. A porous light reflective insulation layer obtained by firing the dye-sensitized solar cell paste according to claim 1.

7. A dye-sensitized solar cell comprising:
the porous light reflective insulation layer according to claim 6 between a porous semiconductor layer and a conductive layer.
